(19) United States
(12) Patent Application Publication
(10) Pub. No.: US 2015/0210900 A1
(43) Pub. Date: Jul. 30, 2015

(54) Adhesive Material for bonding of glass to glass

(71) Applicants: Salah Mahdi Majeed Al-Shukri, Baghdad (IQ); Othman Abdul Rahim Radi AL Hanbali, Sydney (AU)

(72) Inventors: Salah Mahdi Majeed Al-Shukri, Baghdad (IQ); Othman Abdul Rahim Radi AL Hanbali, Sydney (AU)

(21) Appl. No.: 14/552,508

(22) Filed: Nov. 25, 2014

(30) Foreign Application Priority Data
Dec. 3, 2013 (AU) 2013904640

(51) Int. Cl. C09J 11/06; B32B 37/12; B32B 43/00; B32B 37/18

(52) U.S. Cl. CPC C09J 11/06; B32B 37/18; B32B 37/1284; B32B 43/006; B32B 2307/412; B32B 2315/08; B32B 2037/1215; B32B 2551/00

(57) ABSTRACT

The present invention relates to preparation of clear adhesive material. The Phosphazene-based clear adhesive material which comprised of cyclophosphazene, biphenols and aromatic ester groups possess especial optical and thermal characteristics. When adequate amount of Phosphazene-based clear adhesive material applied between two glass surfaces, it affords high optical transparency of at least 90% in the visible wavelengths at the range of 400-700 nm and good adhesive strength, thermo and photo oxidative stability. Phosphazene-based clear adhesive material is a thermoplastic and it offers a possibility of repeatedly disbonding and re-bonding of glass plats once exposed to heat.

### FIELD OF THE INVENTION

The present invention relates to adhesive materials and in particular to an adhesive material for bonding of glass to glass

The invention has been developed primarily for use of bonding glass smooth plates and will be described hereinafter with reference to this application. However, it will be appreciated that the invention is not limited to this particular field of use.

### BACKGROUND OF THE INVENTION

Glass is a nonporous adherend, and therefore adhesive products in the market, which contain water or solvent will not be suitable for glass bonding applications.

The UV curable and heat-setting resin adhesives are widely used. These can be used for glass adhesive bonding. In specialist locations such as dentist surgeries or laboratories or in specialist glass engineering workshops such UV sources are available as an expensive time directional beam apparatus. However in a general sense this is commercially not feasible as it is not possible to sell a UV source with every tube of adhesive sold in the market for home or industrial users.

Further the UV curable and heat-setting resin adhesives are not generally eco-friendly and are permanent.

The present invention seeks to provide an improved adhesive, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, a new adhesive is provided by a Hotmelt Phosphazene-Based Clear Adhesive Material (PN-CAM) comprising: a) Hexachlorocyclotriphosphazene; b) Bisphenol A; and c) methyl 4-hydroxybenzoate. Preferably the equation of relative amounts of each component in mole ratio for the PN-CAM is substantially: (a:b:c) is [1:1:4].

Preferably the Hotmelt phosphazene-based clear adhesive material has the Bisphenols molecule link cyclotriphosphazene molecules and preferably the aromatic ester groups directly bond to cyclotriphosphazene molecules.

According to a second aspect of the present invention, a new adhesive is provided by Hotmelt phosphazene-based clear adhesive material wherein the PN-CAM is fine powder, low porosity and low flow properties wherein the product is transportable and usable with addition of low intensity heat to form a glass to glass transparent bond. Preferably the PN-CAM in glass to glass bond is recyclable back to a fine powder, by a solvent wherein the product is re-usable with addition of low intensity heat to form a glass to glass transparent bond.

The new adhesive can be used for inclusion of this product PN-CAM in the bonding of two glass surfaces including the steps of:
i) Clean all glass surfaces, and ensuring they are dry, smooth and structurally sound.
ii) Apply the product PN-CAM to the glass to be bonded
iii) Expose the glass surface to source of heat till the powder melts and flows;
iv) Force the second glass plate placed on top of the molten, against the other glass plate to remove all trapped air.
v) Leave the bonded glass plates to cool down to room temperature.

The invention also provides a method of forming hotmelt phosphazene-based clear adhesive material including the steps of:
i) adding a solution of bisphenol dropwise over a short period to a stirring solution of hexachlorocyclotriphosphazene.
ii) Stirring the mixture for extended period
iii) subjected to refluxing condition over a short period
iv) Filtering off preciptitated salt with the filtrate evaporated to dryness under reduced pressure.
v) dissolving the obtained material in distilled 1,4-dioxane
vi) adding in drops to sodium 4-methoxycarbonylphenoxide formed from the reaction of methyl 4-hydroxybenzoate and sodium hydride refluxed in 100 mL of 1,4-dioxane for extended period
vii) refluxing the combination with continuous stirring for extended period.
viii) Removing formed sodium chloride and the filtrate evaporated to dryness.
ix) Reconstituting the residue in methylene chloride and the resulting solution washed with distilled water
x) receiving and drying the organic layer over anhydrous MgSO4, with the solution filtered and the solvent removed under reduced pressure.
xi) Drying the product in vacuum oven
   wherein a faint yellow to colorless transparent solid Hotmelt Phosphazene-Based Clear Adhesive Material (PN-CAM) material with a percentage yield of 90% was obtained.

It can be seen that the invention provides the benefit of PN-CAM being a hot-melt adhesive used for adhering glass-glass smooth plates, no treatment such as chemical etching or sandblasting is required to be made at the surface of the glass before applying the adhesive. This is a very specialized glass adhesive material that can be reusable, it is possible to use it again and again and again (just heat collect and apply) recycling process (no product in the market possesses such feature), other glass adhesive product in the market require extra attention during application because once they are dried (cured), they are permanent.

PN-CAM provides good adhesive strength, high optical transparency for bonded glass plates where a very thin adhesive layer of about 0.016 mm is applied between the plates.

PN-CAM possess unique adhesive properties such as odorless, colorless, transparent, solvent- and fillers-free, thermoplastic, moderate melting (softening) temperature, durable and uncross-linkable. These conditions are seldom met by commercially available adhesive polymeric materials, where most of them are cross-linkable and don't afford an ability of dis-bonding and re-bonding after setting and often contain carcinogenic materials and/or solvents.

PN-CAM is thermally stable and it is resistance to the mooxidative degradation up to 380° C.

PN-CAM is a UV light resistance and it has a long-term durability i.e. no yellowing or photodegradation observed when it is exposed to intensive wavelength of Ultraviolet (U.V) light (covering the λ 313 nm) for about 600 hours then the PN-CAM provides high optical transparency in the visible wavelengths at the range of 400-700 nm.

PN-CAM when applied between two glass plates it shows void-free and invisible glueline between the bonded glass plates. PN-CAM is a water proof adhesive.

PN-CAM is soluble in common organic solvents, such as acetone, methyl ethyl ketone, 1,4-dioxane, tetrahydrofuran, chloroform, methylene chloride, tetrachlorocarbon, benzene and toluene.

PN-CAM provides excellent adhesive strength for bonding smooth glass plates, (the adhesive strength exceeds substrate strength, i.e. the bond was stronger than the glass).

Unlike other product in the market, this product is solvent free and its eco-friendly.

Other aspects of the invention are also disclosed.

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 is a chemical equation of a resultant Hotmelt Phosphazene-Based Clear Adhesive Material (PN-CAM) in accordance with a preferred embodiment of the present invention;

FIG. 2 is a chemical equation diagrammatic synthesis steps of products of FIG. 1;

FIG. 3 is a diagrammatic flow diagram of synthesis steps of FIG. 2;

FIG. 4 is a FTIR spectrum of product created from synthesis steps of FIG. 2;

FIG. 5 is a ³¹P NMR spectrum of product created from synthesis steps of FIG. 2;

FIG. 6 is a ¹H NMR spectrum of product created from synthesis steps of FIG. 2;

FIG. 7 is a ¹³C NMR spectrum of product created from synthesis steps of FIG. 2;

Table 1 is a FTIR, ¹H-NMR spectral data, and other properties of product created from synthesis steps of FIG. 2;

Table 2 is a ¹³C NMR spectral data of product created from synthesis teps of FIG. 2;

FIG. 8 is a DSC thermogram of product created from synthesis steps of FIG. 2;

FIG. 9: TG curve of product in N₂ gas created from synthesis steps of FIG. 2;

FIG. 10 is a TG curve of product in O₂ gas created from synthesis steps of FIG. 2;

Table 3 is a summary of the thermal properties of product in N₂ and O₂ Gas created from synthesis steps of FIG. 2;

FIG. 11 is a FTIR spectra of samples UV-irradiated with a HPM-15 lamp for different irradiation times

Table 4 is a test result of adhesive strength of product over glass specimen

Table 5 is a test result of optical properties of product at various wavelengths

FIG. 12 is a UV-vis spectra of the blank microscopic slide and adhesive product created from synthesis steps of FIG. 2;

FIG. 13 is a diagrammatic view of a plurality of glass plates being bonded by the resultant Hotmelt Phosphazene-Based Clear Adhesive Material (PN-CAM) in accordance with a preferred embodiment of the present invention

FIG. 14 is a diagrammatic view of an example of use of bonded glass to glass plates such as for spectacles and bifocals or trifocals by altering optics with different shaped plates.

### DESCRIPTION OF PREFERRED EMBODIMENTS

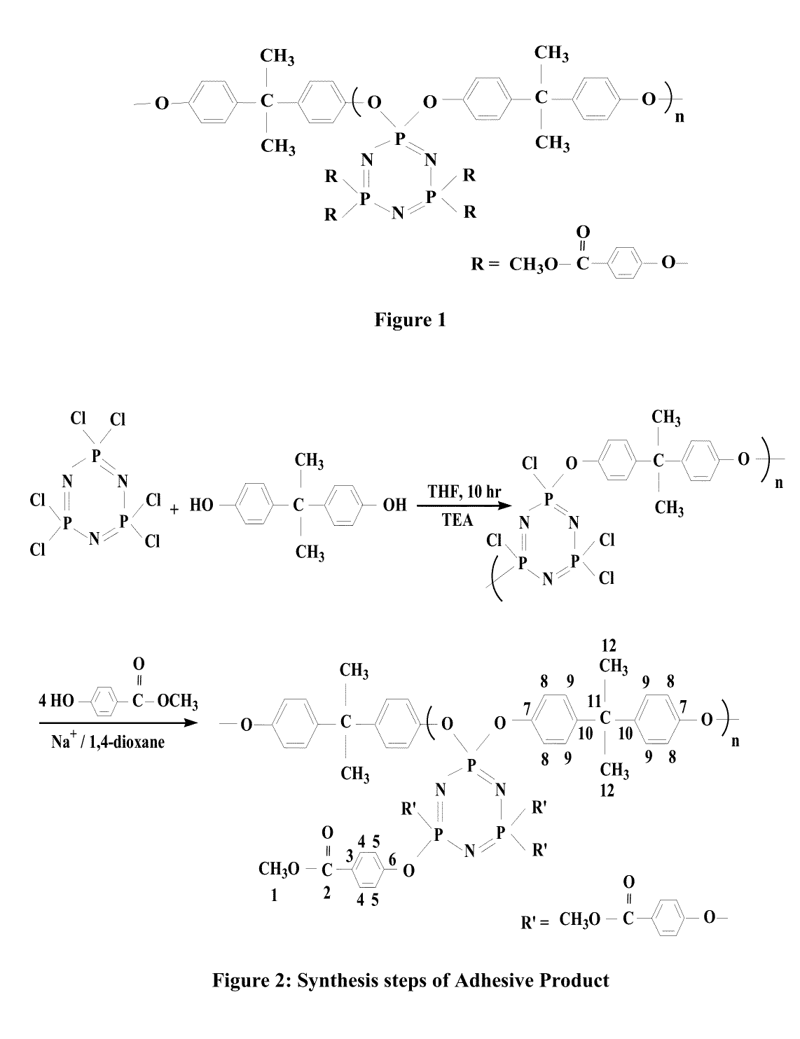

The general chemical molecular structure for the final product shown in FIG. 1 which we gave a name as: the Hotmelt Phosphazene-Based Clear Adhesive Material (PN-CAM) has the main three components for PN-CAM are a) Hexachlorocyclotriphosphazene b) Bisphenol A c) methyl 4-hydroxybenzoate. The equation of relative amounts of each component in mole ratio for the PN-CAM is (a:b:c) is [1:1:4].

The range of composition for main ingredients of the hotmelt phosphazene based clear adhesive material (PN-CAM) that still work to form effective PN-CAM is the range in mole ratio of (a:b) that still can be worked is [1:1.20] meaning about 20% excess for material Bisphenol A (component b).

The adequate amount of component (c), means the amount that is enough to make component (a) is fully substituted. Theoretically four moles of component (c) is an optimal amount that makes one mole of component (a) is fully substituted. For this step we can use even more than 4 moles and the excess will never effect the reaction. This because component (a) will never react (takes) more than four moles of component (c) to make the former fully substituted (see the molecular structure of phosphazene-base clear adhesive material, given in FIG. 1).

Synthesis of Hotmelt Phosphazene-Based Clear Adhesive Material

As shown in FIGS. 1 and 2 the Synthesis of Phosphazene-based clear adhesive material is generally undertaken by the steps of firstly adding a solution of bisphenol dropwise over a short period to a stirring solution of hexachlorocyclotriphosphazene and stirring the mixture for extended period.

Second step is to subject to refluxing condition over a short period, filtering off precipitated salt with the filtrate evaporated to dryness under reduced pressure and dissolving the obtained material in distilled 1,4-dioxane.

A third, step is to add in drops to sodium 4-methoxycarbonylphenoxide formed from the reaction of methyl 4-hydroxybenzoate and sodium hydride refluxed in 100 mL of 1,4-dioxane for extended period.

Fourthly reflux the combination with continuous stirring for extended period.

A fifth step is to remove formed sodium chloride and the filtrate evaporated to dryness. Reconstitute the residue in methylene chloride and the resulting solution washed with distilled water and receive and dry the organic layer over anhydrous MgSO4, with the solution filtered and the solvent removed under reduced pressure.

Finally drying the product in vacuum oven to obtain solid Hotmelt Phosphazene-Based Clear Adhesive Material (PN-CAM)

Looking at the process in more detail, to a stirring solution of hexachlorocyclotriphosphazene (PN) (10.0 g 0.02 mol) in 100 mL of freshly distilled THF (inside a 250 mL 2-necked round bottom flask fitted with a reflux condenser, a magnetic stirrer, and placed in an oil bath).

A solution of bisphenol A (7.07 g, 0.023 mol) in 50 mL of freshly distilled THF and triethylamine (17.0 mL, 0.12 mol) was added dropwise via a dropping funnel over a period of 15 minutes.

The content of the flask stirred for 10 hours and subsequently, subjected to refluxing condition for 30 minutes.

Triethylamine hydrochloride salt that precipitated was filtered off. The filtrate was evaporated to dryness under reduced pressure.

The obtained material was dissolved in 100 mL freshly distilled 1,4-dioxane and carefully added via a dropping funnel to sodium 4-methoxycarbonylphenoxide formed from the reaction of methyl 4-hydroxybenzoate (12.78 g, 0.08 mol) and sodium hydride (2.0 g, 0.08 mole) refluxed in 100 mL of 1,4-dioxane for 2 hours

The content of the flask was refluxed with continuous stirring for 10 hours.

Sodium chloride that formed was removed by suction filtration and the filtrate evaporated to dryness.

The residue was reconstituted in 200 mL of methylene chloride and the resulting solution washed with distilled water (75 mL).

The organic layer was received and dried over anhydrous MgSO₄, the solution was filtered and the solvent removed under reduced pressure.

The product was then dried at 100° C. in vacuum oven for 2 hours.

A Faint yellow to colorless transparent solid material with a percentage yield of 90% was obtained.

Structural Analysis of Product

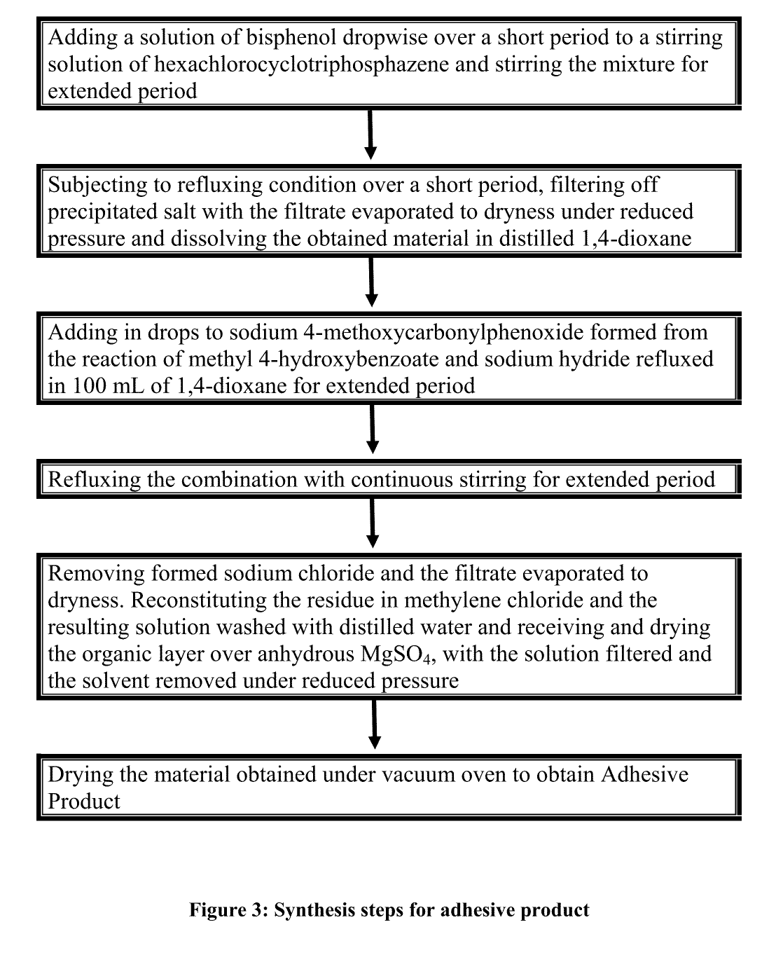

As detailed FIGS. 2 and 3 show the synthesis steps in forming the Phosphazene-based clear adhesive material of FIG. 1.

The particular characteristics of this material as formed by the defined process provides a material with unexpected properties that make it particularly useful in the glass to glass bonding process.

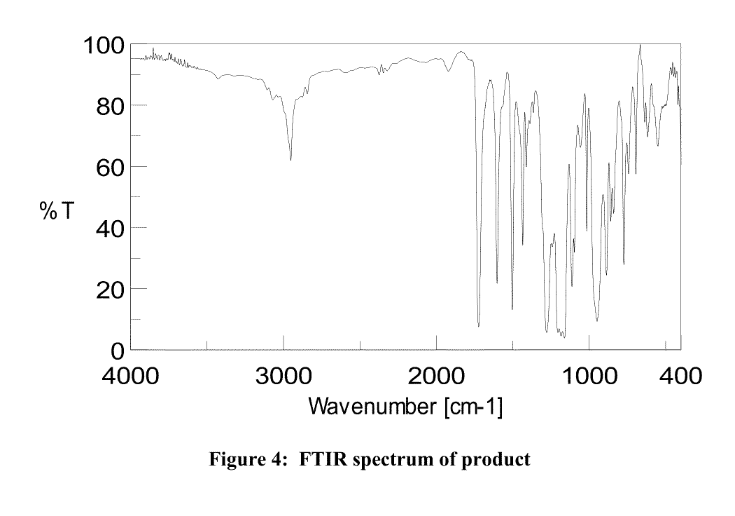

in The FTIR spectrum of product depicted in FIG. 4 shows the characteristic bands of the phosphazene ring, mainly at 1273, 1211 cm⁻¹ assigned to the asymmetric and symmetric stretching of P═N group, respectively and at 1161 cm⁻¹ assigned to the stretching PO—C bond (of PO—Ar groups). The absorption frequencies of C═O appeared at 1720 cm⁻¹.

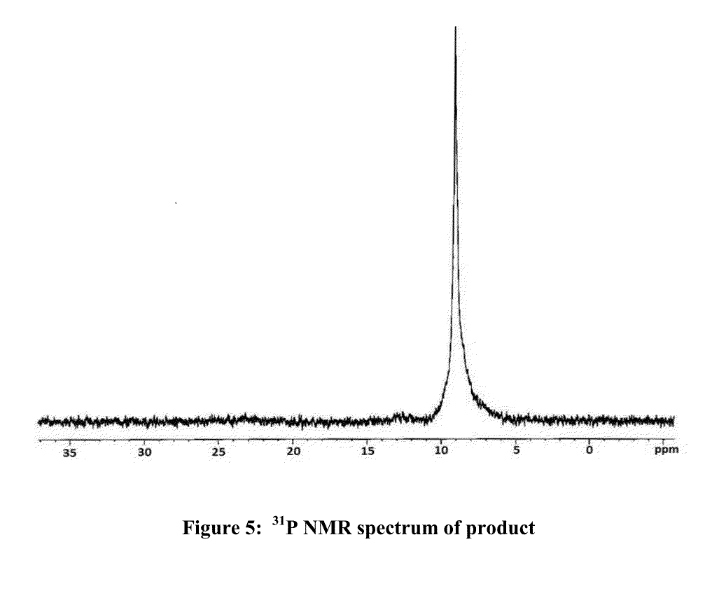

The ³¹PNMR spectrum reveals a single broad resonance at δ 9.2 ppm as shown in FIG. 5, which indicates a complete replacement of the residual chlorines by ester groups.

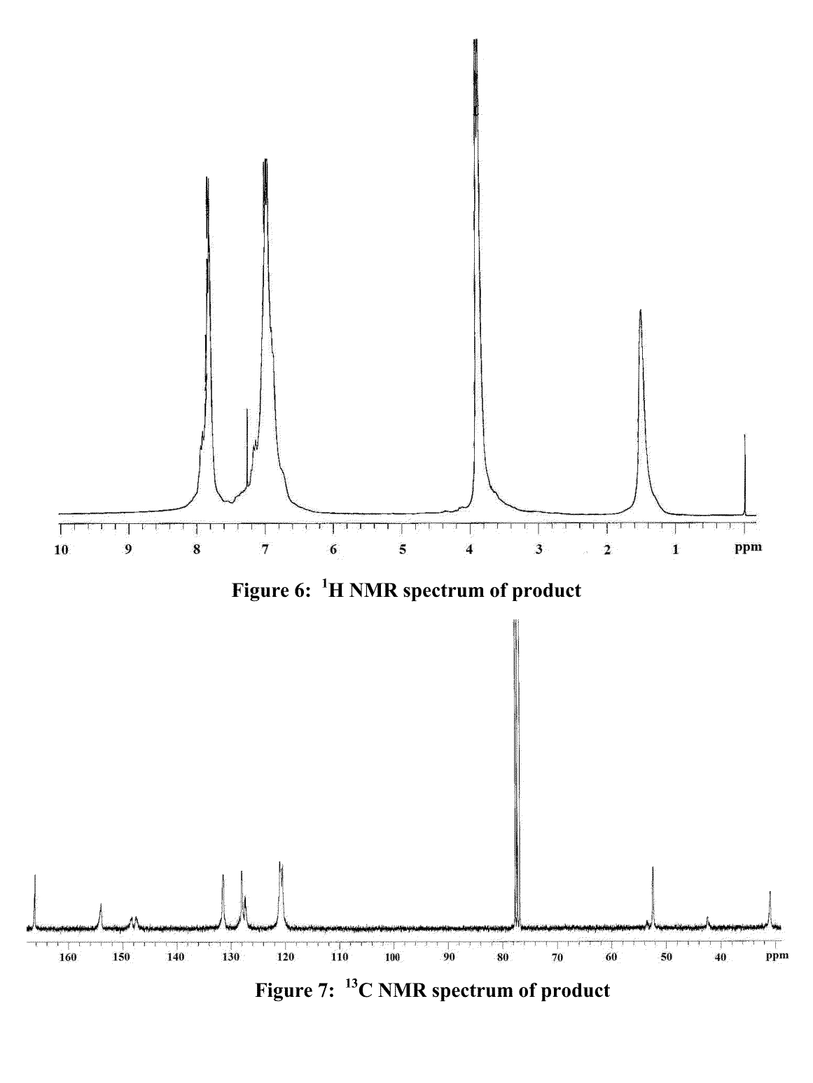

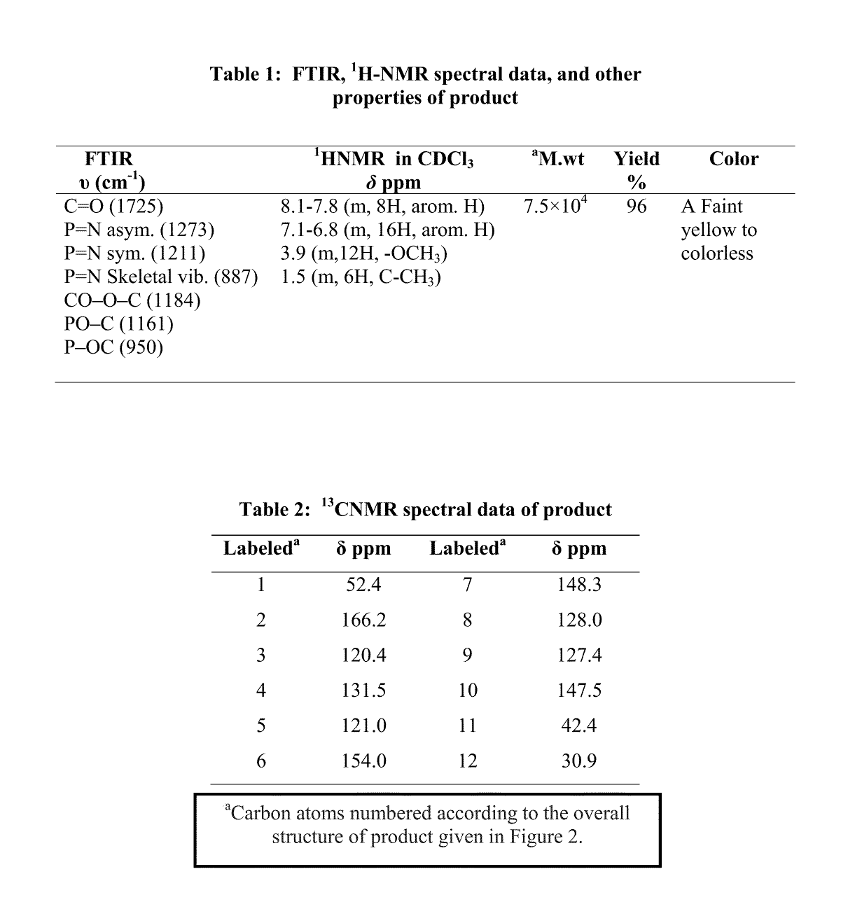

Assignments of the related peaks in the FTIR, ¹H NMR spectrum (FIG. 6), and other data of the product are given in Table 1, and ¹³C NMR spectrum given in FIG. 7 and data are tabulated in Table 2.

### Thermal Analysis

DSC analysis: The sample was annealed at heating rate of 10° C./min (for both heating and cooling). For the first scan, the sample was heated from −20° C. to at least 200° C. and hold for about 3 minutes before cooled (at 10° C./min) back to −20° C. The second scan was performed after 2-3 minutes of waiting time then heated up to 200° C.

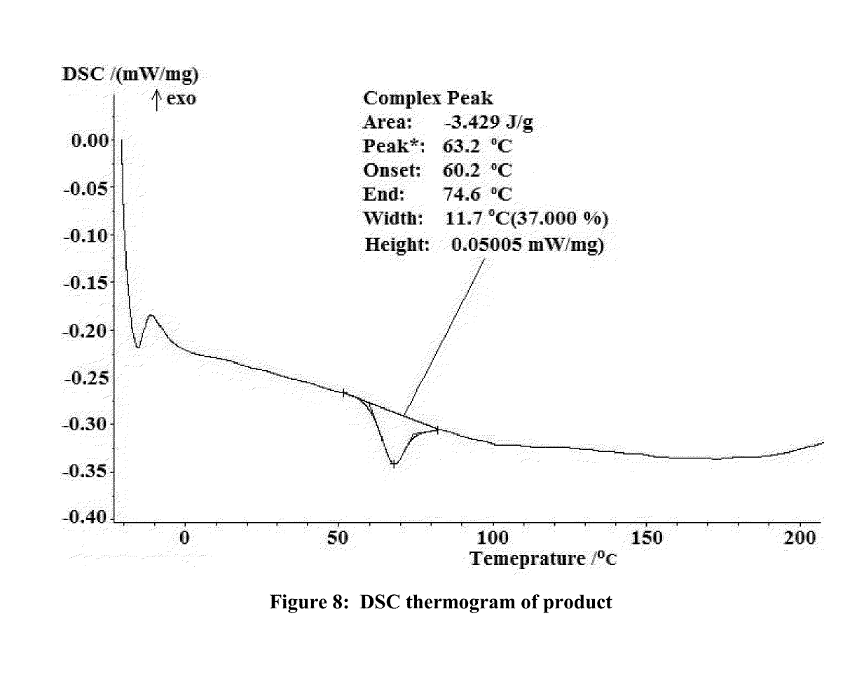

The glass transition temperatures (Tg) was determined from the inflection point of the DSC thermogram of the second scan. The thermogram in FIG. 8 shows clear sole endothermic transitions appeared at 63° C. corresponding to Tg.

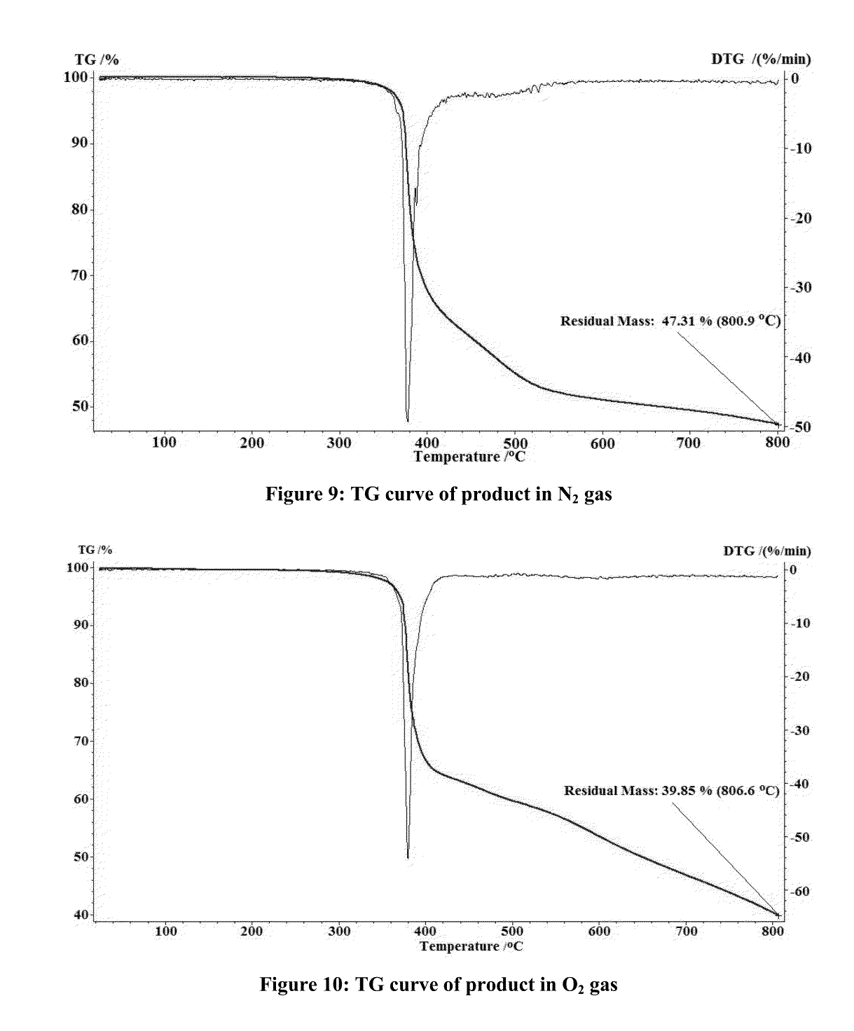

The thermal gravimetric analysis (TGA) curve in atmosphere of nitrogen and oxygen gas showed good thermal stability, indicated by the absence of any significant weight loss up to 350° C. as illustrated in FIGS. 9 and 10.

In both atmospheres, the thermograms showed one major decomposition step occurred at 380° C., this indicate that the product is thermally very stable even under tough conditions of stream oxygen gas.

The total weight loss under nitrogen and oxygen were 53% and 60% respectively. A summary of the thermal analysis data is presented in Table 3.

### Photo Stability

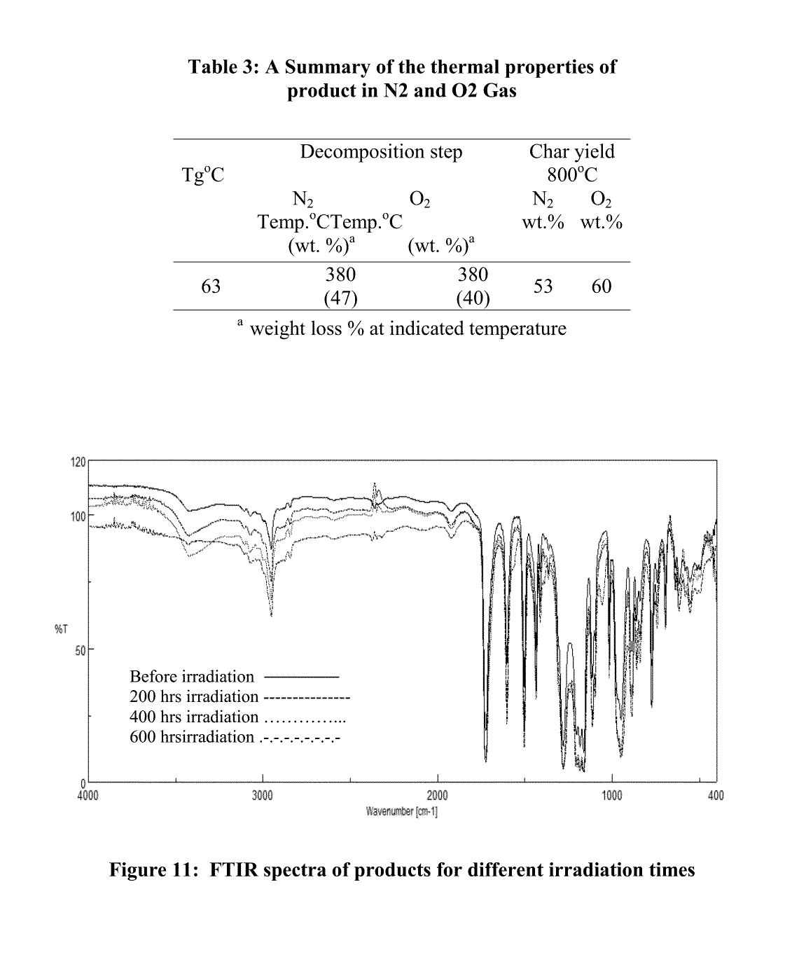

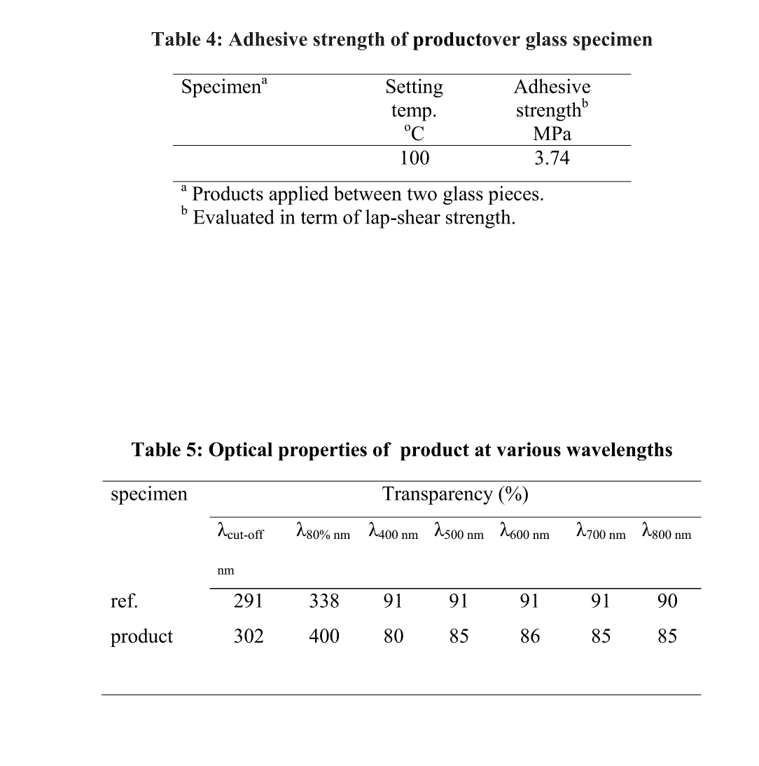

Referring to FIG. 11, the UV irradiation process of product was performed on a weatherometer (type Q-Panel) with a low-pressure mercury (LPM) lamp (type UVB-313 EL made in USA, 40 w, the main emission wavelength covered the 313 nm range).

The FTIR spectra of product after long time of irradiation by UV light (100, 200, 300, and 600 hrs) does not show any changes of the characteristics peaks in comparison to the spectrum before irradiation. The carbonyl peak of the ester groups at 1725 cm⁻¹ was not shifted or changed, also no new peak was observed in the spectra indicating that there are no changes in the microstructure of the product even with increasing UV-irradiation time to 600 hours.

### Tensile Shear Strength

Measurements of the tensile shear strength (adhesive strength) of a single-lap bonded joint was carried out according to the standard DIN EN 1465 using INSTRON 1195 Tensiometer with pulling rate of 2 mm/min and maximum applied force of 200 kg at room temperature using glass test plates with the dimensions of (100×25 mm).

As shown in FIG. 13, the thickness of the adhesive layer between the two glass plats was found to be ≈0.016 mm (±0.003 mm) for all specimens and an average of five readings was taken for calculating the (Fmax) value with standard deviation of ≈±6.60.

The adhesive strength was found to be 3.74 MPa, this strength of bonded joint is likely, due to the interaction surface between the active hydroxy sites on glass with the polar methoxycarbonylphenoxy group, data are given in Table 4.

### Optical Characteristics

Hotmelt Phosphazene-based clear adhesive material exhibits good optical transparency at various wavelengths as illustrated in Table 5. The UV cut-off wavelength (λ_{cut-off}) of the blank microscopic slides ref. (used as a reference for comparison) at 289 nm whereas that of product was about 300 nm and its wavelength of 80% transparency (λ_{80%}) was 364 nm.

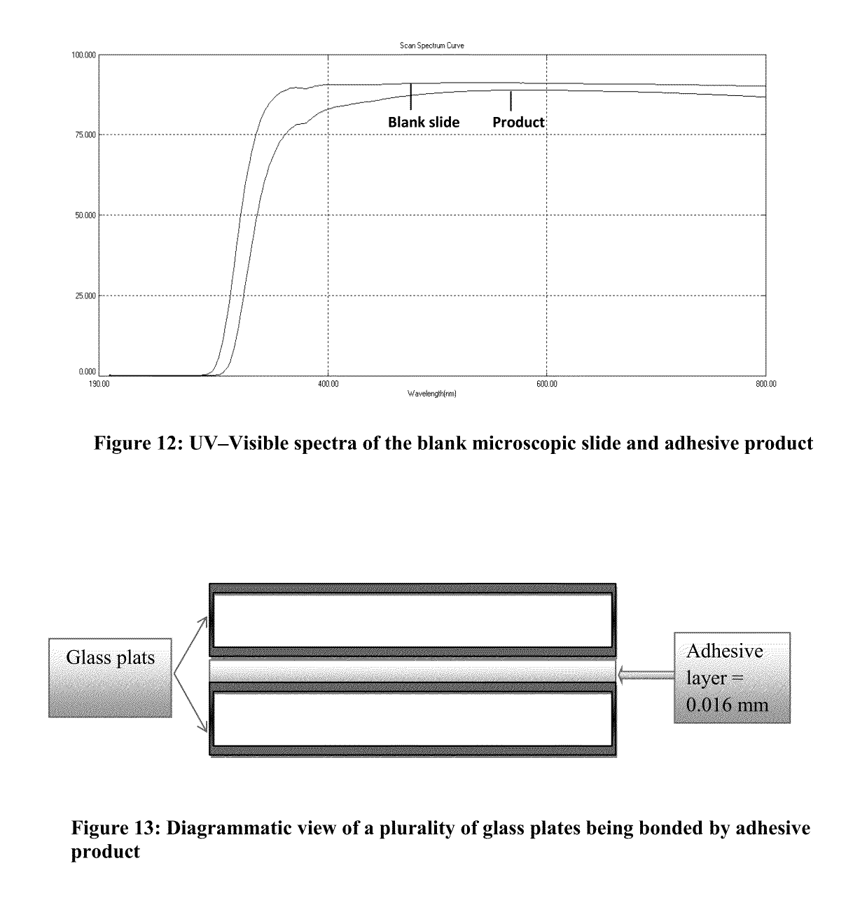

In comparison to the transparency of blank slid, the maximum transparency of at least 90% was observed within the wavelengths of the visible light at the range of 400-700 nm, as shown in FIG. 12, also given in this spectrum the spectrum of the blank microscopic slide as a reference for comparison and other spectroscopic data are given in Table 5.

### Alternative Synthesis Procedures for PN-CAM:

The First Alternative Method of Preparation (Procedure)

To a stirring solution of hexachlorocyclotriphosphazene (PN) (10.0 g, 0.02 mol) in of freshly distilled THF (inside a 250 mL 2-necked round bottom flask fitted with a reflux condenser, a magnetic stirrer, and placed in an oil bath).

A solution of bisphenol A (7.07 g, 0.023 mol) in 50 mL of freshly distilled THF and triethylamine (17.0 mL, 0.12 mol) was added dropwise via a dropping funnel over a period of 15 minutes.

The content of the flask stirred for 10 hours and subsequently, subjected to refluxing condition for 30 minutes.

Triethylamine hydrochloride salt that precipitated was filtered off. The filtrate was evaporated to dryness under reduced pressure.

The obtained product was dissolved in 100 mL of freshly distilled 1,4-dioxane inside a 250 mL round bottom flask and then a solution of methyl 4-hydroxybenzoate (12.78 g, 0.084 mol) of and triethylamine (34 mL, 0.24 mol) in 50 ml of 1,4-dioxane was added via a dropping funnel over a period of 10 minutes. The content of the flask was refluxed with continuous stirring for 30 hours.

The triethylamine hydrochloride salt that formed was removed by suction filtration and the filtrate evaporated to dryness.

The residue was reconstituted in 150 mL of methylene chloride and the resulting solution washed with distilled water (75 mL).

The organic layer was received and dried over anhydrous Na₂SO₄, the solution was filtered and the solvent removed under reduced pressure.

The solid product was washed with hot methanol. The product was then dried at 100° C. under reduced pressure (0.03 Torr) for 6 hours.

A Faint yellow solid material with a percentage yield of 80% was obtained.

The Second Alternative Method of Preparation (Procedure)

Bisphenol A (7.07 g, 0.023 mol) and sodium metal or sodium hydride (1.0 g, 0.046 mol) in 50 mL of dry THF was stirred and refluxed for three hours inside a 200 mL round bottom flask fitted with a reflux condenser, a magnetic stirrer, and placed in an oil bath. The di-sodium salt of Bisphenol A formed after 3 hours of stirring and refluxing, then the content of the flask was cooled down to room temperature.

To this mixture (di-sodium salt of Bisphenol A) a solution of hexachlorocyclotriphosphazene (10.0 g, 0.02 mol) in 50 mL of freshly distilled THF was added portion wise.

The content of the flask stirred for two hours and then subjected for refluxing conditions for 10 hours

The Sodium chloride that formed was removed by suction filtration and the filtrate evaporated to dryness.

The obtained product was dissolved in 100 of freshly distilled 1,4-dioxane inside a 250 mL round bottom flask and a solution of methyl 4-hydroxybenzoate (35.01 g, 0.23 mol) and triethylamine (48 mL, 0.34 mol) in 50 ml of 1,4-dioxane was added via a dropping funnel over a period of 10 minutes. The content of the flask was refluxed with continuous stirring for 30 hours.

The residue was reconstituted in 150 mL of methylene chloride and the solution washed with distilled water (75 mL).

The organic layer was received and dried over anhydrous Na₂SO₄, the solution was filtered and the solvent removed under reduced pressure.

The solid product was washed with hot methanol. The product was then dried at 100° C. under reduced pressure (0.03 Torr) for 6 hours.

A Faint yellow solid material with a percentage yield of 80% was obtained.

Note here that in all reaction steps the solvents THF and 1,4-dioxane were dried over sodium metal and freshly distilled before used.

Use of the Material

### Example 1

### Use as Glass Bonding

Installation of this product PN-CAM (procedure for application) in a particular form and in a particular way starts with all glass surfaces must be clean, dry, smooth and structurally sound. For every 10 cm2 apply 50 mg powder (PN-CAM) (5 mg cm2). Expose the glass surface to source of heat (light burner such as cigarette lighter) between 200°-350° C. while the heat source exposed to the glass surface (bottom), and on top still the powder (melt and flow). Because this product is amorphous therefore, we cannot define the melting point. When the second glass plate placed on top of the molten, the two plates will be twisted with force against each other to remove all trapped air (air bubbles). Leave the bonded glass plates to cool down to room temperature.

In the recycling process: To recover the adhesive material, center the two plates over the burner till the two plates separated, then immerse the plats for few minutes in any common solvent such as acetone, THF, chloroform, methylene chloride, methyl ethyl ketone, then evaporate the solvent under reduced pressure and collect the adhesive powder again PN-CAM.

Adhesives for bonding glass and related substrates are selected based on polarity, available functional groups, and compatibility. The polymeric materials used to bond glass are generally transparent, colorless and do not change the optical characteristics of the glass, heat-setting resins, thermally stable, water and UV resistant, fillers and solvent free.

Because glass is a non-porous adherend, therefore, any adhesive containing water or solvent will not be suitable for bonding applications.

The most useful polymeric adhesive materials are polyvinyl butyral, phenolic butyral, phenolic nitrile, styrene-modified polyesters and styrene monomer based adhesives, thermosetting epoxies and acrylics are also used. Most of glass adhesive bonding materials are either UV curable or heat setting resin.

Most of the glass adhesive resins are either cross-linked or thermosets when cured, therefore after setting, their ability for disbonding and rebonding virtually becomes almost impossible. This because, the chemical structure as well as the molecular weight and composition of the polymer materials are altered when they subjected to curing conditions.

Hotmelt Phosphazene-based clear adhesive material doesn't contain cross-linkable terminal groups at it structure; therefore the product neither undergoes crosslink reaction nor changes of the molecular structure or degradation of the molecular weight when they subjected to curing conditions.

Phosphazene-based clear adhesive material is a hot-melt adhesive used for adhering glass-glass smooth plats, no treatment such as chemical etching or sandblasting is required to be made at the surface of the glass before applying the adhesive.

Hotmelt Phosphazene-based clear adhesive material:
a) provides good adhesive strength, high optical transparency for bonded glass plates where a very thin adhesive layer of about 0.016 mm is applied between the plates.
b) possesses unique adhesive properties such as odorless, colorless, transparent, solvent- and fillers-free, thermoplastic, moderate melting (softening) temperature, durable and uncross-linkable. These conditions are seldom met by commercially available adhesive polymeric materials, where most of them are cross-linkable and don't afford an ability of dis-bonding and re-bonding after setting.
c) is thermally stable and it is resistance to thermooxidative degradation up to 380° C.
d) is a UV light resistance and it has a long-term durability i.e. no yellowing or photodegradation observed when it is exposed to intensive wavelength of Ultraviolet (U.V) light (covering the λ 313 nm) of for about 600 hours
e) provides high optical transparency in the visible wavelengths at the range of 400-700 nm.
f) when applied between two glass plates it shows void-free and invisible glueline between the bonded glass plates.
g) is a water proof adhesive.
h) is soluble in common organic solvents, such as acetone, methyl ethyl ketone, 1,4-dioxane, tetrahudrofuran, chloroform, methylene chloride, tetrachlorocarbon, benzene and toluene.
i) provides excellent adhesive strength for bonding smooth glass plates, (the adhesive strength exceeds substrate strength, i.e. the bond was stronger than the glass).
j) bonded mechanism to the glass plates is based on the surface interaction between the active polar sites on glass with the polar groups present in chemical structure of the adhesive material.
k) is specifically used for bonding (adhering) glass-glass surfaces.)
l) has paramount importance for specific glass industrial applications such as bonding of lenses, photo frames, decorative glass bevel windows, liquid crystals displays and glass display cabinets.
m) can be used to glue glass on glass, as in mosaics, or for simply fixing broken glass. This adhesive is ideal for crystal, and both clear and colored glass.
n) comes off of skin easily and will not glue fingers together like many super glues. This is the ideal glue for glass if children will be doing the gluing
o) is safe to use compare to other commercially available adhesive materials in the market especially those containing volatile carcinogenic solvents.
p) is Eco friendly and can be simply recovered after use by dissolving it into suitable solvent yet maintaining its original properties.
q) manufacturing procedure is cheap and can be easily produced in industrial scale

### Examples

The new adhesive material can be used for several applications including for replacement a cracked screen (with—without) digitizer for, iphones, Ipad, samsung galaxy S3, tablets and others. (The screen/glass part, it doesn't look like it is glass but for Samsung S3 it is glass). The transparency after use will be almost 90%. This can be achieved by melting/softening the adhesive glue powder.

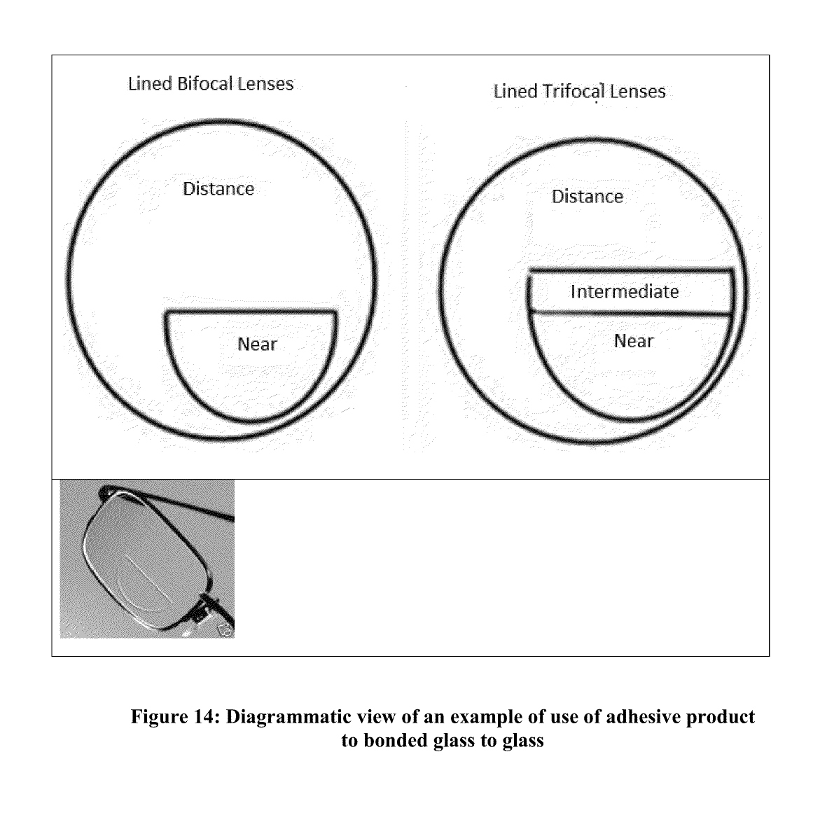

A second use is for spectacles as shown in FIG. 14. These days, most people choose line-free progressive lenses, conventional bifocals and trifocals have some advantages over progressives. In particular, bifocal and trifocal lenses usually provide wider lens areas for reading and computer work than progressive lenses. Also, there are many special-purpose bifocal and trifocal lens designs available, including special glasses for computers.

A third use is for manufacturing a water tight containers such as Home aquarium or to glue glass on glass, as in mosaics, or for simply fixing broken glass. This adhesive is ideal for crystal, and both clear and colored glass. It comes off of skin easily and will not glue fingers together like many super glues.

Glass Patch clear adhesive film can be formed that holds broken glass together for safer and more secure place such as classrooms.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### TERMINOLOGY

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the adhesives and bonding industries.

1. A Hotmelt Phosphazene-Based Clear Adhesive Material (PN-CAM) comprising:
a) Hexachiorocyclotriphosphazene;
b) Bisphenol A; and
c) methyl 4-hydroxybenzoate.

2. Hotmelt phosphazene-based clear adhesive material according to claim 1 wherein the equation of relative amounts of each component in mole ratio for the PN-CAM is substantially:
(a:b:c) is [1:1:4].

3. Hotmelt phosphazene-based clear adhesive material according to claim 1 or 2 wherein the range of composition for main ingredients of the Hotmelt phosphazene based clear adhesive material (PN-CAM) in mole ratio of (a:b) is substantially [1:1.20] meaning about 20% excess for material Bisphenol A (component b).

4. Hotmelt phosphazene-based clear adhesive material according to claim 1, 2 or 3 wherein the adequate amount of component (c) that is enough to make component (a) fully substituted is substantially four moles of component (c) or more to one mole of component (a).

5. Hotmelt phosphazene-based clear adhesive material according to claim 1 wherein Bisphenols molecule link cyclotriphosphazene molecules.

6. Hotmelt phosphazene-based clear adhesive material according to claim 5 wherein aromatic ester groups directly bond to cyclotriphosphazene molecules.

7. Hotmelt phosphazene-based clear adhesive material according to claim 1 wherein the average molecular weight of hotmelt phosphazene-based clear adhesive material is about 4.5×10⁴ with the polydispersity of about (Mw/Mn) 2.1-2.5.

8. Hotmelt phosphazene-based clear adhesive material according to any one of claims 1 to 7 wherein the PN-CAM is fine powder, low porosity and low flow properties wherein the product is transportable and usable with addition of low intensity heat to form a glass to glass transparent bond.

9. Hotmelt phosphazene-based clear adhesive material according to any one of claims 1 to 8 wherein the PN-CAM in glass to glass bond is recyclable back to a fine powder, by a solvent wherein the product is re-usable with addition of low intensity heat to form a glass to glass transparent bond.

10. A method of using Hotmelt phosphazene-based clear adhesive material according to any one of claims 1 to 8, for inclusion of this product PN-CAM in the bonding of two glass surfaces including the steps of:
i. Clean all glass surfaces, and ensuring they are dry, smooth and structurally sound.
ii. Apply the product PN-CAM to the glass to be bonded
iii. Expose the glass surface to source of heat till the powder melts and flows;
iv. Force the second glass plate placed on top of the molten, against the other glass plate to remove all trapped air.
v. Leave the bonded glass plates to cool down to room temperature.

11. A method of using Hotmelt phosphazene-based clear adhesive material according to claim 10 substantially in the range of for every 10 cm2 apply 50 mg powder (PN-CAM) (5 mg/cm2).

12. A method of using Hotmelt phosphazene-based clear adhesive material according to claim 10 wherein the low range heat is a light burner such as cigarette lighter between 200-350° C. for applying the heat source to the glass surfaces bottom and on top.

13. A method of recycling Hotmelt phosphazene-based clear adhesive material according to any one of claims 1 to 8, for recovering of this product PN-CAM in the bonded two glass surfaces including the steps of:
i. centre the two plates over the burner till the two plates separated,
ii. immerse the plates for few minutes in any common solvent such as acetone, THF, chloroform, methylene chloride, methyl ethyl ketone,
iii. evaporate the solvent under reduced pressure and
iv. collect the adhesive powder PN-CAM.

14. A method of forming hotmelt phosphazene-based clear adhesive material of any one of claims 1 to 9 wherein the reaction of cyclotriphosphazene with at least a stoichiometric amount of bisphenols and hydrogen halide removal to produces poly(organocyclotriphosphazene).

15. The method according to claim 12 wherein poly(organocyclotriphosphazene) reacted with adequate amount of aromatic ester salt.

16. The method according to claim 13 wherein the amount of the aromatic ester equal to at least four times of cyclotriphosphazene.

17. The method according to claim 13 wherein the salt of aromatic ester is preformed from the reaction of aromatic ester and sodium metal or sodium hydride at refluxing temperature.

18. The method according to claim 13 wherein a solution of added drop-wise over a short period to the suspension of the aromatic ester salt, then reaction subjected to refluxing temperature.

19. The method according to claim 12 wherein the dry solvent tetrahydrofuran and dry hydrogen halide removal used to prepare poly(organocyclotriphosphazene).

20. The method according to claim 12 wherein the hydrogen halide removal is equal to four times of cyclotriphosphazene.

21. The method according to claim 15 wherein the nonaqueous solvent 1,4-dioxane is used to prepare the salt of aromatic ester.

22. A method of forming hotmelt phosphazene-based clear adhesive material including the steps of:
i. adding a solution of bisphenol dropwise over a short period to a stirring solution of hexachlorocyclotriphosphazene.
ii. Stirring the mixture for extended period
iii. subjected to refluxing condition over a short period
iv. Filtering off preciptitated salt with the filtrate evaporated to dryness under reduced pressure.
v. dissolving the obtained material in distilled 1,4-dioxane
vi. adding in drops to sodium 4-methoxycarbonylphenoxide formed from the reaction of methyl 4-hydroxybenzoate and sodium hydride refluxed in 100 mL of 1,4-dioxane for extended period
vii. refluxing the combination with continuous stirring for extended period.
viii. Removing formed sodium chloride and the filtrate evaporated to dryness.
ix. Reconstituting the residue in methylene chloride and the resulting solution washed with distilled water
x. receiving and drying the organic layer over anhydrous MgSO4, with the solution filtered and the solvent removed under reduced pressure.
xi. Drying the product in vacuum oven
wherein a faint yellow to colorless transparent solid Hotmelt Phosphazene-Based Clear Adhesive Material (PN-CAM) material with a percentage yield of 90% was obtained.
